(19) United States
(12) Patent Application Publication
(10) Pub. No.: US 2007/0290875 A1
(43) Pub. Date: Dec. 20, 2007

(54) INTERACTIVE WIRELESS INTERFACE

(75) Inventor: Fernando D. Pedrazzoli Pazos, Madrid (ES)

Correspondence Address: IBM CORPORATION, IPLAW SHCB/40-3, 1701 NORTH STREET, ENDICOTT, NY, 13760, US

(73) Assignee: INTERNATIONAL BUSINESS MACHINES CORPORATION, Armonk, NY (US)

(21) Appl. No.: 11/751,770

(22) Filed: May 22, 2007

(30) Foreign Application Priority Data
Jun. 8, 2006 (EP) 06300574.8

(51) Int. Cl. G09B 21/00

(52) U.S. Cl. 340/825.19; 340/5.1; 340/825.72; 704/271; 340/5.61; 340/407.2

(57) ABSTRACT

The invention discloses a portable device that allows users to deal with objects that require intervention to operate. The portable device can detect and identify the object and execute an action desired by the user on the object. A compatible system in the object allows the object to interactively communicate with the portable device. The invention can be easily integrated with public areas, schools, traffic lights, public transportation, elevators, security doors and the like.

### FIELD OF THE INVENTION

The present invention relates to a system and method for enabling a user to interact with an object. More specifically, it relates to a system and method for allowing disabled and visually impaired users to deal with objects that need user intervention to operate.

### BACKGROUND OF THE INVENTION

The modern urban environment contains objects that need user intervention for their operation. One example of such an object that requires user intervention is an elevator. A user of the elevator needs to press a button mounted on a wall in order to call the elevator to the floor where the user is standing. Some other devices that require user intervention to operate include button-activated crossing lights, fire alarms and secured doors activated by user identification elements such as a badge or a password. In all the abovementioned cases, the user needs to locate some sort of activation switch and perform some action to operate the objects. Usually such objects are based on control mechanisms that allow the user to interact with the object. The control mechanisms may maintain identification information about the user for authenticating the user before initiating interaction. Some of the control mechanisms are included in secure systems that need correct instructions to operate and may initiate interactive dialog to give the user the expected results needed. Thus it is necessary that the user is able to provide some intervention such as instructions to operate the object. Not responding to these instructions or interactive dialog would mean non-operation of the object.

The use of such objects (that require intervention to operate) may be inconvenient for people who are not familiar with an unknown environmental area. In particular, people with disabilities, particularly the visually impaired or blind face problems dealing with such objects. In fact, most such objects fail to take into account the needs of disabled people.

Some of the limitations associated with the use of such objects by disabled or visually impaired people include:

### 1. The disabled user cannot detect the location of the object that needs intervention to operate.

### 2. There is no interactive mechanism for initiating communication between the disabled or visually impaired user and the object.

### 3. There is no mechanism for the disabled or visually impaired user to initiate an emergency process in case of paramount necessity, because the visually impaired user cannot locate and/or interact with the object.

Because of the abovementioned limitations, disabled users find it difficult to deal with objects that need intervention to operate. What is required is a system and method for providing disabled users with the ability to operate objects requiring intervention.

### OBJECTS AND SUMMARY OF THE INVENTION

One object of the present invention is to allow disabled users, including visually impaired people, to traverse unknown environments without difficulty.

Another object of the present invention is to make the objects that require intervention to operate be easily detected and identified by disabled users.

Yet another object of the present invention is to make it possible for disabled users to easily locate objects that require intervention to operate and establish the desired interaction with such objects using wireless technology.

According to an embodiment of the invention there is provided a portable device for allowing a user to operate an object the portable device comprising a control logic capable of detecting and identifying the object, a communication logic for establishing interaction with the object, and a user interface specially designed for disabled persons.

According to another embodiment of the invention there is provided a system for allowing a user to operate an object, the system comprising a wireless device enabling communication between the user and the object, an authentication logic for enabling the identification and authentication of the user and the object, a user interface specially adapted for disabled users, the user interface allowing the user to specify a desired action to be performed on the object, an operating sequence logic for implementing the action desired by the user, an interlock mechanism locking the communication between the user and the object, and an interactive remote controller interfacing the wireless device with the interlock mechanism and the authentication logic, the interactive remote controller managing the communication between the user and the object.

According to yet another embodiment of the invention there is provided a system for allowing an object to interactively communicate with a portable device carried by a user. The system comprises a memory for storing an encoded context message, a communication unit for establishing communication with the portable device and a control unit for executing the steps required to allow the object to interactively communicate with the user and to execute the actions desired by the user.

According to still yet another embodiment of the invention there is provided a method for allowing a user to deal with an object, the method comprising the steps of receiving a context message by the user regarding the object, authenticating the object from the information in the context message, exchanging protocol authorization between the user and the object, identifying the action to be initiated by the user, initiating communication between the user and the object for exchanging information regarding the action, locking the communication between the user and the object until the exchange of information regarding the action is complete, and executing the action to allow the user to deal with the object.

### BRIEF DESCRIPTION OF DRAWINGS

The above and other items, features and advantages of the invention will be better understood by reading the following detailed description of the invention in conjunction with the accompanying drawings wherein:

FIG. 1 is a block diagram showing an embodiment of the present invention;

FIG. 2 is a flowchart showing a method for allowing a user to execute a desired action on an object using a portable device, in accordance with an embodiment of the present invention;

FIG. 3 is a block diagram showing an architecture of a portable device that enables the user to interact with the object in accordance with an embodiment of the present invention;

FIG. 4 is a block diagram showing an architecture of the object; and

FIG. 5 shows a typical implementation of the actions initiated by the user on the object.

### DETAILED DESCRIPTION OF THE INVENTION

The invention discloses a portable device that allows users to deal with objects that require intervention to operate. The user can carry the portable device and uses the device for detecting and identifying an object and executing an action desired by the user on the object. A compatible system in the object allows the object to interactively communicate with the portable device.

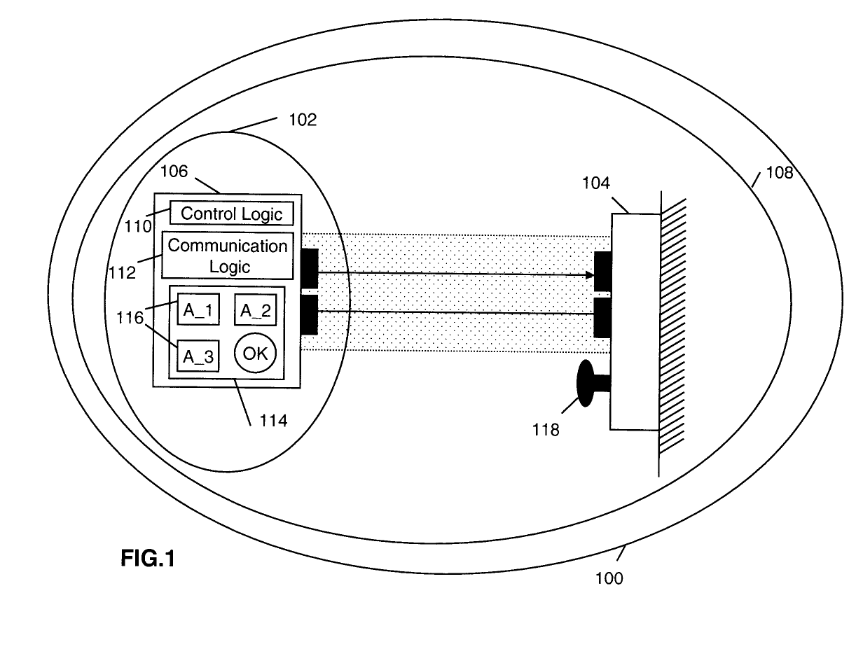

FIG. 1 is a block diagram showing the implementation for an embodiment of the present invention. A context 100 is the urban environment such as public area, home, school or system transportation where the present invention may operate. Context 100 comprises a user 102 and an object 104, wherein object 104 needs intervention to operate. Some examples of objects that need intervention to operate include elevators, traffic lights, fire alarms and secured doors. For example, an elevator requires the user to select an “up” or “down” button in order to call the elevator. When the elevator arrives and the user steps in, the user must then press the button associated with the particular floor that the user wants to reach. If the elevator gets stuck while the user is in it, then the user must be able to find the emergency button located inside the elevator. In the case of a traffic light, the user must first locate the pedestrian walk button before pressing it to trigger the pedestrian walk symbol to appear. User 102, who may be a disabled person, carries a portable device 106 that enables user 102 to interact with object 104. Object 104 is situated in a secure zone 108. Secure zone 108 is an area in the vicinity of object 104 where the object and portable device 106 can communicate with each other and exchange data between them.

Portable device 106 comprises a control logic 110, a communication logic 112 and a user interface 114. Control logic 110 is capable of detecting and identifying object 104, and allows user 102 to execute an action desired by the user on the object. Communication logic 112 establishes interaction between portable device 106 and object 104. User interface 114 provides an interface on portable device 106 to user 102 and is specially adapted for use by a disabled user.

Control logic 110 allows identification and authentication of both user 102 and object 104 before initiating interactive communication to enable the user to deal with the object. Communication logic 112 enables communication between portable device 106 carried by user 102 and object 104. The communication between object 104 and portable device 106 may take place in at least two ways. Portable device 106 may request communication with object 104 by sending a signal to the object. Alternatively, portable device 106 may receive a context message from object 104 to initiate communication. User interface 114 is specifically adapted for use by disabled users and contains features that allow disabled users to conveniently make use of portable device 106.

In various embodiments of the invention, control logic 110 may be implemented using a microprocessor, a micro-controller, and Application Specific Integrated Circuit (ASIC), a Field Programmable Gate Array (FPGA), a System-on-Chip (SoC) circuit, or combinations thereof. It would be apparent to one skilled in the art that a variety of hardware configurations may be used to implement control logic 110, without deviating from the spirit and scope of the present invention. In one embodiment of the present invention, communication logic 112 is an IEEE 802.11b compliant wireless device and includes network capabilities. IEEE 802.11b is a commonly used standard, but the present invention is not limited to this standard. Other wireless standards that may be used include IEEE 802.11a, IEEE 802.11x, hyperlan/2, Bluetooth, IrDA, and HomeRF. In one embodiment of the present invention, user interface 114 is a tactile board and contains features that allow disabled users to conveniently make use of portable device 106. For example, the keys of the tactile board may have Braille characters for easy use by visually impaired users. User interface 114 may also incorporate a speech recognition system for allowing the disabled user to operate portable device 106 through voice commands. User Interface 114 includes switches 116 that allow user 102 to select a required action by pressing a dedicated switch or combination of switches corresponding to the action. Both user interface 114 and switches 116 can be arranged on the surface of any mobile support like palm, glove or handle devices. User interface 114 may also include attachments such as numeric key pads to allow password entry for security doors or to operate an elevator to indicate the destination floor user 102 wants to reach. User interface 114 of portable device 106 further includes features to notify user 102 about the presence of object 104. User interface 114 may use voice messages, sensorial messages (including Braille characters reproduced to the fingertips of user 102), text messages on a display or a combination of such messages for notifying the user. For example, the presence of a traffic light may be announced through a voice message while the presence of an elevator may be announced by using a vibration.

Object 104 may also include a manual intervention mechanism 118 for allowing the user to manually control object 104. Further object 104 must respond to various functions such as:

a) Daily life actions that initiate interactive dialog to give user 102 the expected needed results. For example, the daily life actions could be calling an elevator, activating traffic lights and any other actions dedicated to monitor control mechanism.
b) secure actions that need obtaining the correct instructions to operate. One example of a secure action could be opening doors protected by password operated locks. The user needs to introduce a right combination of numbers to open such locks.

It will be apparent to one skilled in the art that context 100 may comprise multiple secure zones, with each secure zone comprising multiple objects that require intervention to operate.

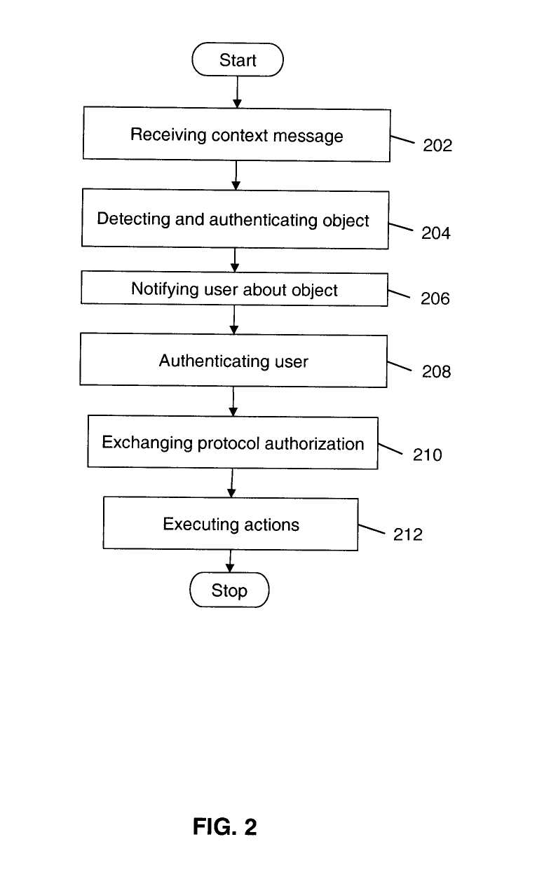

FIG. 2 is a flowchart showing the method for allowing user 102 to execute a desired action on object 104 using portable device 106. User 102, for example, a disabled person, is located within context 100, which may be some urban environment such as public area, home, school or system transportation in which the present invention operates. Context 100 includes object 104 that needs intervention to operate, lying within secure zone 108. Object 104 may be connected to a continuous power source which can send a signal constantly at regular intervals. The signal activates a response from portable device 106 as soon as user 102 enters secure zone 108. Portable device 106 sends a signal to object 104 alerting the object to its presence. Object 104 sends a context message to portable device 106 upon detecting the presence of the portable device. At step 202, the context message is received by portable device 106. The context message notifies user 102 that the zone containing object 104 is a secure zone that was developed to conduct the user, for example, disabled or visually impaired people, to the right destination. The context message also contains object information required to detect object 104 and other information related to the environment identification such as elevator commands or security door commands and so on. At step 204, portable device 106 detects and authenticates object 104 by decoding the context message to extract object information to serve as reference for future actions. Portable device 106 notifies user 102 of the presence of object 104 at step 206. User 102, desires initiation of an interactive communication with object 104, pushes appropriate switches 116 arranged on user interface 114 of portable device 106. At step 208, user 102 is authenticated by comparing the content of the context message received from object 104 with user information pre-loaded in portable device 106. At step 210, object 104 and portable device 106 exchange the protocol authorization to operate and confirm the initiation of communication. At step 212, object 104 and portable device 106 interactively communicate to execute the actions desired by user 102.

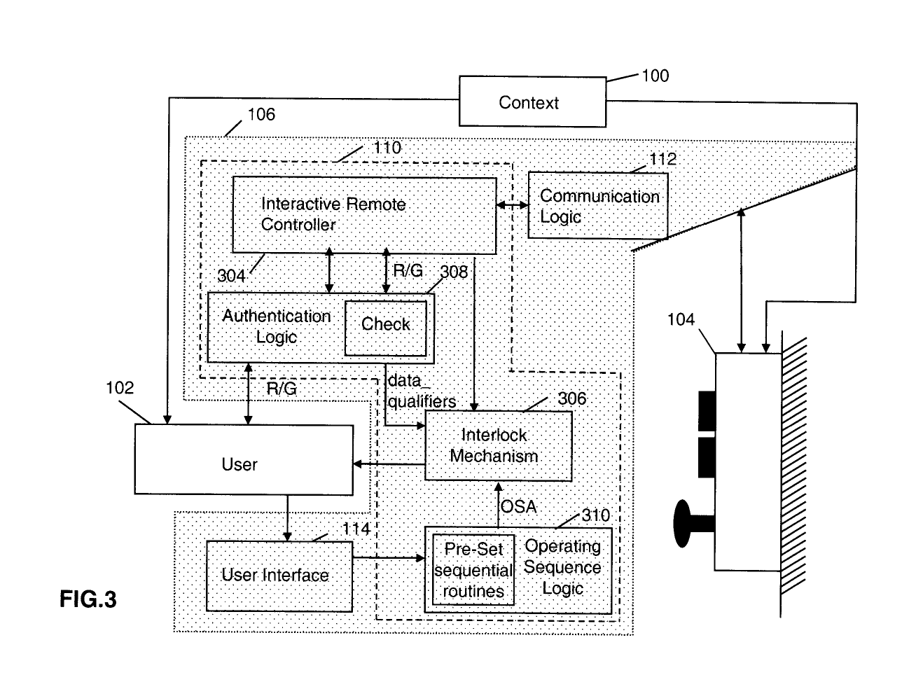

FIG. 3 is a block diagram showing a detailed architecture of portable device 106 in accordance with an embodiment of the present invention. Portable device 106 includes communication logic 112, an interactive remote controller 304, an interlock mechanism component 306, authentication logic 308, an operating sequence logic 310 and user interface 114. Communication logic 112 enables communication between object 104 and portable device 106. Communication logic 112 receives context messages sent by object 104 and forwards these messages to Interactive Remote Controller 304 that interfaces with communication logic 112. Interactive Remote Controller 304 monitors the transfer of data between Communication logic 112 and authentication logic 308. Authentication logic 308 manages the bi-directional arbitration of the pending action initiated by object 104 to user 102 and the reverse. Authentication logic 308 contains pre-stored user information and authenticates object 104 by comparing the context message sent by the object with the user information. User interface 114 allows user 102 to initiate desired actions. Operating Sequence Logic 310 contains pre-set sequential routines that implement the actions initiated by user 102. Operating Sequence Logic 310 delivers the pre-set sequential routines to interlock mechanism component 306. Interlock mechanism component 306 locks the transfer of data between object 104 and portable device 106 until the data transfer related to pending action initiated by user 102 is complete. Further, Interlock mechanism component 306 indicates to user 102 that the communication between object 104 and portable device 106 has been well established and running.

In a situation where user 102 enters secure zone 108, object 104 detects portable device 106 carried by user 102 and sends a context message to portable device 106 notifying user 102 of the presence of object 104. The data in the context message is transferred via communication logic 112 to interactive remote controller 304. Interactive remote controller 304 transfers the context data to authentication logic 308 where the data is internally checked and decoded and the corresponding data qualifiers are extracted. Authentication logic 308 uses data qualifiers to authenticate object 104. Once object 104 has been authenticated, authentication logic informs user 102 about the presence of object 104. Authentication logic 308 also sends the data qualifiers to interlock mechanism component 306.

User 102 who wants to initiate an interactive communication with object 104 indicates the desired action by pushing appropriate switches 116 located on user interface 114 of portable device 106. User 102 may press a dedicated switch or combination of switches corresponding to the action. The user identification is realized by comparing the content of the context message with the user information issued from authentication logic 308 in portable device 106. The user information is pre-loaded in the “check” part of authentication logic 308 to serve as reference during the configuration phase of portable device 106. Once user 102 has been authenticated, the pre-set sequential routines in Operating Sequence Logic 310 implement the actions initiated by user 102. The pre-set sequential routines correspond to some embedded preliminary scenario that can be applied for managing the action desired by user 102. Operating Sequence Logic 310 delivers the pre-set sequential routines to interlock mechanism component 306. Interlock mechanism component 306 locks the transfer of data between object 104 and portable device 106 until the data transfer related to pending action initiated by user 102 is complete. Further, Interlock mechanism component 306 indicates to user 102 that the communication between object 104 and portable device 106 has been well established and running.

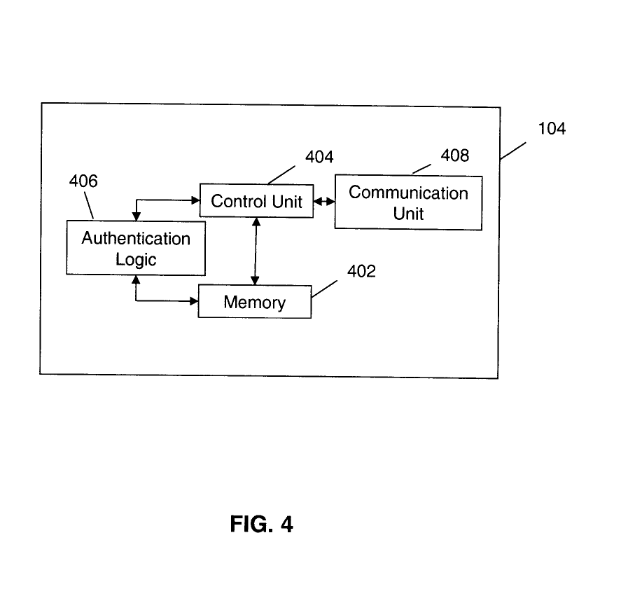

FIG. 4 shows the architecture of object 104 in accordance with an embodiment of the present invention. Object 104 is based on a control mechanism and includes a system compatible with portable device 106 that allows the object to interactively communicate with the portable device carried by user 102. The system comprises a memory 402, a control unit 404, an authentication logic 406 and a communication unit 408. Memory 402 stores encoded context messages for sending to portable device 106. Memory 402 may be implemented using, by way of non-limiting example, a Random Access Memory (RAM), Read Only Memory (ROM), Electrically Programmable Read Only Memory (EPROM), Electrically Erasable Programmable Read Only Memory (EEPROM), Flash memory, a magnetic storage medium, an optical storage medium, and any combination thereof. Control unit 404 executes the application logic for object 104. Further, control unit 404 interactively communicates with various transducers and/or electrical circuits present in object 104. For instance, control unit 404 issues the control signals to the electronic circuit driving the motors of an elevator, or to the motors directly, to operate the elevator in accordance with commands received from portable device 106 carried by user 102. Control unit 404 may be implemented using a microprocessor, a micro-controller, and Application Specific Integrated Circuit (ASIC), a Field Programmable Gate Array (FPGA), a System-on-Chip (SoC) circuit, or various combinations thereof. It would be apparent to one skilled in the art that a variety of hardware configurations may be used to implement control unit 404 based on the specific application, without deviating from the spirit and scope of the present invention.

Authentication logic 406 is communicatively coupled with memory 402 and control unit 404. Authentication logic 406 identifies and authenticates portable device 106 carried by user 102. In various embodiments, memory 402 stores authentication information used for authenticating portable device 106. The authentication information may include, by way of non-limiting example, a list of unique portable device identifiers authorized to operate object 104, a list of trusted authentication certificate issuing authorities, an authentication logic, and combinations thereof. Communication Unit 408 establishes communication between object 104 and portable device 106. In an embodiment of the present invention, communication unit 406 is an IEEE 802.11b compliant wireless device and includes network capabilities. IEEE 802.11b is a commonly used standard, but the present invention is not limited to this standard. Other wireless standards that may be used include IEEE 802.11a, IEEE 802.11x, hyperlan/2, Bluetooth, IrDA, and HomeRF.

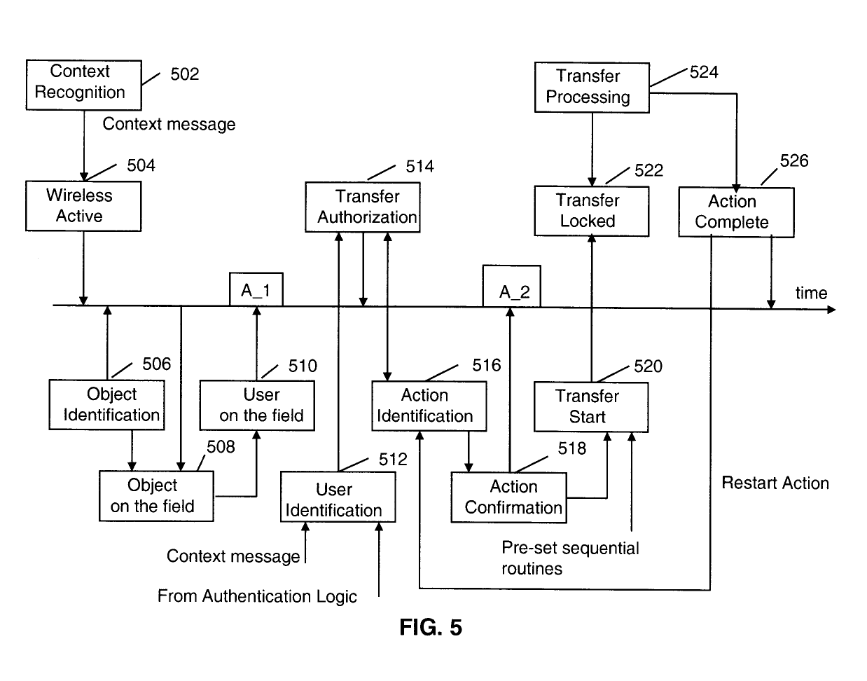

FIG. 5 shows a method for implementing the actions initiated by user 102 on object 104. At step 502, context recognition is provided by the generation of a pre-defined context message. The context message is encoded within object 104 that needs intervention to operate. At step 504, the context message radiates around secure zone 108 and uses the wireless facilities to communicate with potential portable devices 106 carried by users 102. The context message contains information related to the environment identification such as elevator commands or security doors and so on. At step 506, portable device 106 detects object 104, decodes and identifies the context message to serve as reference for future actions. At step 508, portable device 106 informs user 102, moving in secure zone 108, that there exists object 104 in the vicinity. User 102, intending to initiate an interactive communication with object 104 confirms user presence at step 510 by using some dedicated switch (A_1) located on the User interface. At step 512, user identification is realized by comparing the content of context message with the user information “data_qualifier” issued from the Authentication logic 308 available in portable device 106. The user information is pre-loaded in the “check” part of the Authentication logic 308 to serve as reference during the configuration phase of portable device 106. At step 514, both portable device 106 and object 104 exchange the protocol authorization to operate and give confirmation to begin the data transfer. At step 516, both portable device 106 and object 104 exchange interactive communication to define which of the actions has to be initiated. This depends on the request of either object 104 or user 102 as defined below:
User 102 intends to sense the location of object 104.
User 102 responds to the request of object 104 which initiates an emergency process by granting the pending action in case of paramount necessity.
User 102 intends to deal with object 104 to initiate a desired action.

At step 518, user 102 confirms the action by selecting the dedicated tactile switch (A_2) located on the User interface. At step 520, Operating Sequence Logic 310 initiates the action in accordance with the user request. Operating Sequence Logic 310 contains pre-set sequential routines corresponding to some embedded preliminary scenario to automatically manage a chosen situation upon user request. At step 522, interlock mechanism component 306 locks the data transfer between portable device 106 and object 104 until the current transfer is completed. Locking avoids any undesirable parasitic communication coming from other systems.

At step 524, object 104 executes the action initiated by user 102 via portable device 106 provided in the disclosed invention. At step 526, object 104 acknowledges the action initiated by user 102. Once the action initiated by user 102 is complete, portable device 106 provides the user with the possibility to restart a new action if necessary. In case user 102 wants to initiate another action, the control moves back to step 516 and all the steps following the step are implemented to complete the action.

The system of the present invention, based on context recognition and user identification provides many advantages over existing solutions. The system provides a robust solution especially dedicated for disabled people such as the blind or the visually impaired. The system ensures complete transfer security by identifying all components involved in this process before initiating the interactive communication. Thus, the context is identified (step 502), the object is identified (steps 506 and 508), the user is identified (steps 510 and 512) and the action is identified, (step 516) before the interactive communication between user 102 and object 104 is established.

It will be apparent to one skilled in the art that the system provided by the present invention is not limited to the objects cited above. The invention finds applications in operating any objects that require user-intervention to operate. Some examples of such objects include ticket operated gates and turnstiles, button operated intercommunicators, electric switch operated doors, door bells, light switches, switches for appliances such as air conditioner or heater.

The system can be easily integrated with an urban environment and associated structures. For example the invention may be applicable in public areas, schools, traffic lights, public transportation, elevators, security doors, security systems that needs to be enabled or disabled in case of paramount necessity and any other areas where disabled people are not familiar with an unknown environment. The portable device provided by the invention is user-friendly and can be easily used and manipulated.

In the description, specific embodiments of the present invention have been described by way of examples with reference to the accompanying figures and drawings. One of ordinary skill in the art will appreciate that various modifications and changes can be made to the embodiments without departing from the scope of the present invention as set forth in the claims below. Accordingly, the specification and figures are to be regarded in an illustrative rather than a restrictive sense, and all such modifications are intended to be included within the scope of present invention.

What is claimed is:

1. A portable device for allowing a user to operate an object, the portable device comprising:
a communication logic establishing interaction between the portable device and the object;
a control logic capable of detecting and identifying the object, the control logic allowing the user to execute an action on the object; and
a user interface specially adapted for use by disabled persons.

2. The portable device of claim 1, wherein the communication logic comprises a wireless device.

3. The portable device of claim 1, wherein the user interface comprises a tactile board allowing the user to specify a desired action to be performed on the object.

4. The portable device of claim 3, wherein the tactile board comprises a plurality of switches for receiving user input.

5. The portable device of claim 3, wherein the tactile board comprises a speech recognition system receiving voice instructions and an audio system transmitting voice messages.

6. The portable device of claim 1, wherein the control logic comprises an authentication logic enabling the identification and authentication of the user and the object.

7. The portable device of claim 6, wherein the authentication logic comprises pre-loaded identification information of the user and the object.

8. The portable device of claim 1, wherein the control logic comprises an operating sequence logic implementing the action desired by the user.

9. The portable device of claim 8, wherein the operating sequence logic comprises at least one pre-set sequential routine for implementing the action desired by the user.

10. The portable device of claim 1, wherein the control logic comprises an interactive remote controller managing the communication between the user and the object.

11. The portable device of claimed in claim 1, wherein the control logic further comprises an interlock mechanism locking the communication between the user and the object, the locking of communication preventing any undesirable communication from other systems.

12. The portable device of claim 11, wherein the interlock mechanism notifies the user about the status of communication between the portable device and the object.

13. A system for allowing a user to operate an object, the system comprising:
a wireless device enabling communication between the user and the object;
an authentication logic for enabling the identification and authentication of the user and the object;
a user interface specially adapted for disabled users, the user interface allowing the user to specify a desired action to be performed on the object;
an operating sequence logic for implementing the action desired by the user;
an interlock mechanism locking the communication between the user and the object; and
an interactive remote controller interfacing the wireless device with the interlock mechanism and the authentication logic, the interactive remote controller managing the communication between the user and the object.

14. The system of claim 13, wherein the object is selected from a group consisting of elevator, traffic light, fire alarm, secured door, ticket operated gate, ticket operated turnstile, button operated intercommunicator, switch operated door, doorbell, light switch and appliance switch.

15. The system of claim 13, wherein the object comprises a manual intervention mechanism for allowing the user to deal with the object.

16. The system of claim 13, wherein the interactive remote controller can transfer qualifiers to the Interlock Mechanism to lock the communication between the user and the object.

17. A system for allowing an object to interactively communicate with a portable device carried by a user, the system comprising:
a memory for storing an encoded context message;
a communication unit for establishing communication with the portable device; and
a control unit for executing the steps required to allow the object to interactively communicate with the user and execute the actions desired by the user.

18. A system of claim 17, wherein the context message comprises information related to the identification of the object.

19. A system of claim 17 further comprising an authentication logic for identifying and authenticating the portable device.

20. A method for allowing a user to deal with an object, the method comprising the steps of:
receiving a context message by the user regarding the object;
authenticating the object from the information in the context message;
exchanging protocol authorization between the user and the object;
identifying the action to be initiated by the user;
initiating communication between the user and the object for exchanging information regarding the action;
locking the communication between the user and the object until the exchange of information regarding the action is complete; and
executing the action to allow the user to deal with the object.
